(19) United States
(12) Patent Application Publication
(10) Pub. No.: US 2012/0308878 A1
(43) Pub. Date: Dec. 6, 2012

(54) SECONDARY BATTERY AND MANUFACTURING METHOD THEREOF

(76) Inventors: Kazuya SAKASHITA, Osaka (JP); Yuki Watanabe, Osaka (JP); Tadashi Nemoto, Osaka (JP); Takuya Ootani, Osaka (JP); Hiroshi Okamoto, Osaka (JP)

(21) Appl. No.: 13/482,257

(22) Filed: May 29, 2012

(30) Foreign Application Priority Data
May 30, 2011 (JP) 2011-120348

(51) Int. Cl. H01M 10/04; H01M 2/14; H01M 6/00; H01M 2/04

(52) U.S. Cl. 429/185; 29/623.1

(57) ABSTRACT

Provided is a large secondary battery including a lamination body in which multiple positive electrode plates, multiple negative electrode plates, and multiple separators are laminated, having a structure in which the lamination body is not shifted. The secondary battery with high reliability and a manufacturing method thereof is provided, in which there is no abnormal state even if an external force such as vibration is applied. Positive electrode plate (2), negative electrode plate (3), and separator (4) are laminated and integrated to form a predetermined number of layers of a lamination body unit. A plurality of the lamination body unit are stacked to form an electrode assembly (1). Uneven surfaces, i.e., salients (21) and recesses (23) are formed on contacting surfaces of the lamination body units to be stacked. Using the uneven surfaces, the lamination body units are positioned and stacked to form a secondary battery (RB1).

### CROSS-REFERENCE TO RELATED APPLICATIONS

This application is based on Japanese Patent Application No. 2011-120348 filed on May 30, 2011, the contents of which are hereby incorporated by reference.

### BACKGROUND OF THE INVENTION

1. Field of the Invention

The present invention relates to a secondary battery, and particularly to a secondary battery including a large lamination type electrode assembly in which multiple positive electrode plates and multiple negative electrode plates are laminated, and a manufacturing method thereof.

2. Description of Related Art

Recent years, a lithium secondary battery, which has high energy density and can realize small size and lightweight, is used as a power supply battery of a portable electronics device such as a mobile phone or a notebook personal computer. In addition, because it can support a large capacity, the lithium secondary battery has been noted as a motor drive power source for an electric vehicle (EV) or a hybrid electric vehicle (HEV), or as a storage battery for storing electric power.

The lithium secondary battery has a structure including an encapsulating case constituting a battery can, an electrode assembly housed in the encapsulating case, in which a positive electrode plate and a negative electrode plate are opposed via a separator, electrolytic solution filled in the same, a positive electrode collector terminal connected to positive electrode collector tabs of a plurality of positive electrode plates, a positive electrode external terminal connected electrically to the positive electrode collector terminal, a negative electrode collector terminal connected to negative electrode collector tabs of a plurality of negative electrode plates, and a negative electrode external terminal connected electrically to the negative electrode collector terminal.

In addition, as the electrode assembly, there are known a winding type and a lamination type. The winding type electrode assembly has a structure in which the positive electrode sheet and the negative electrode sheet are united via a separator therebetween and wounded as a unit. The lamination type electrode assembly has a structure in which a plurality of positive electrode plates and a plurality of negative electrode plates are laminated via separators.

In the lithium secondary battery including the lamination type electrode assembly, the electrode assembly in which a plurality of positive electrode plates and a plurality of negative electrode plates are laminated via separators is housed in the encapsulating case, and nonaqueous electrolytic solution is filled in the same. There are provided the positive electrode collector terminal connected to the positive electrode collector tabs of the individual positive electrode plates, the external terminal connected electrically to the positive electrode collector terminal, the negative electrode collector terminal connected to the negative electrode collector tabs of the negative electrode plates, and the external terminal connected electrically to the negative electrode collector terminal.

In order to manufacture the secondary battery having a large capacity using the lamination type electrode assembly, it is necessary to increase areas of the positive electrode plate and the negative electrode plate, to increase the number of laminated layers, and to increase amount of the electrolytic solution. In addition, in order to secure a predetermined power generation capacity, it is maintain a space between the positive electrode plate and the negative electrode plate to be a predetermined small value. If this space between the positive electrode plate and the negative electrode plate is increased, an internal resistance may increase so that the power generation capacity may be lowered.

Therefore, as to the secondary battery including the lamination type electrode assembly, there is already proposed a secondary battery suppressing lamination misalignment and a short circuit of electrode plates as a structure in which an electrode assembly support is disposed and is fixed the battery can (see, for example, Patent Document 1: JP-A-2010-50111).

In order to manufacture a secondary battery having a large power generation capacity, it is important to increase electrode plate areas of the positive electrode plate and the negative electrode plate, and to increase the number of laminated layers. In addition, it is important to suppress the lamination misalignment of the electrode plates and to maintain the space between the positive electrode plate and the negative electrode plate to be a predetermined small value.

In addition, it is desirable that even if the number of laminated layers is large, the lamination step can be performed easily. Further, it is desirable that the lamination up to a predetermined number of laminated layers can be performed stably by repeating a predetermined operation, and that the laminated electrode assembly is stable without causing lamination misalignment after the lamination is completed.

In particular, in order to manufacture the secondary battery in which multiple (for example, a few tens of layers of) positive electrode plates, negative electrode plates, and separators are laminated, it is desirable to manufacture a large thickness of electrode assembly by stacking a plurality of lamination bodies having a predetermined lamination thickness, and it is desirable that there should be no misalignment between the stacked lamination bodies.

Further, in addition to that the plurality of lamination bodies are not misaligned with each other, it is desirable that the lamination body group (electrode assembly) should not be shifted in the battery can so that the collector terminal or the external terminal is not broken.

### SUMMARY OF THE INVENTION

Therefore, in view of the above-mentioned problem, it is an object of the present invention to provide a secondary battery and a manufacturing method thereof in which lamination bodies can be stacked without misalignment even in a large secondary battery including the lamination body in which multiple positive electrode plates, negative electrode plates, and separators are laminated, the lamination body is not shifted even if an external force such as vibration is applied, and a terminal portion is not shifted or broken so that high reliability can be realized.

In order to achieve the above-mentioned object, the present invention provides a secondary battery including an electrode assembly in which positive electrode plates and negative electrode plates are laminated via separators to form a plurality of layers, an encapsulating case for housing the electrode assembly, a lid member for sealing the encapsulating case, and electrolytic solution filled in a battery can constituted of the encapsulating case and the lid member. The electrode assembly is constituted of a plurality of stacked lamination body units in which the positive electrode plates, the negative electrode plates, and the separators are laminated to form a predetermined number of layers, alignment and anti-misalignment engaging portions are provided to contacting surfaces of the lamination body units to be stacked, and the lamination body units are positioned and stacked using the alignment and anti-misalignment engaging portions.

With this structure, because the lamination body units are positioned and stacked using the alignment and anti-misalignment engaging portions, the lamination body units can be stacked at a correct position without misalignment. Therefore, even in a large secondary battery including the lamination body in which the multiple positive electrode plates, the multiple negative electrode plates, and the separators are laminated, the lamination body is not shifted, the terminal portion is not shifted, and there is no damage to the terminal portion, even if an external force such as vibration is applied. Thus, it is possible to provide the secondary battery having high reliability.

In addition, in the secondary battery having the above-mentioned structure of the present invention, the alignment and anti-misalignment engaging portions have engaging uneven surfaces. With this structure, the lamination body units are stacked by engaging the uneven surfaces. Therefore, the lamination body units can be stacked at a correct position without misalignment.

In addition, in the secondary battery having the above-mentioned structure of the present invention, the uneven surfaces are formed using tape members adhered to outer surfaces of the lamination body units. With this structure, the uneven surfaces for preventing misalignment can be formed easily only by adhering the tape members to predetermined portions of the lamination body unit.

In addition, in the secondary battery having the above-mentioned structure of the present invention, the tape members are made of adhesive tape superior in insulating property and thermal resistance. With this structure, it is possible to insulate between the lamination body units to be an electricity generating body. Even if the lamination body unit becomes high temperature, its durability is maintained so that the predetermined uneven surfaces can be securely maintained.

In addition, in the secondary battery having the above-mentioned structure of the present invention, the lamination body units includes first units and second units each of which has predetermined uneven surfaces on the upper surface and the lower surface, the first units and the second units are stacked alternately and repeatedly so as to form the electrode assembly, and the uneven surfaces formed on the upper surface and the lower surface of the first unit engage with the uneven surfaces formed on the lower surface and the upper surface of the second unit. With this structure, the uneven surface of the upper surface of the first unit is engaged with the uneven surface of the lower surface of the second unit, and the uneven surfaces of the upper surface of the second unit is engaged with the uneven surfaces of the lower surface of the first unit. Therefore, when the first units and the second units are stacked alternately, the individual uneven surfaces are engaged with each other and are not shifted from each other.

In addition, in the secondary battery having the above-mentioned structure of the present invention, the lamination body units has an uneven surface formed on the lower surface and an uneven surface formed on the upper surface, which constitute the engaging uneven surfaces. With this structure, only by stacking the lamination body units in order, the uneven surfaces thereof are engaged with each other and are not shifted from each other.

In addition, in the secondary battery having the above-mentioned structure of the present invention, recesses and salients engaging the uneven surfaces are formed on a ceiling of the lid member facing the electrode assembly and on a bottom surface of the encapsulating case facing the electrode assembly. With this structure, the encapsulating case and the electrode assembly are not shifted from each other, and the lid member and the electrode assembly are not shifted from each other. Even if an external force such as vibration is applied, the electrode assembly in the battery can is not shifted, and there is no abnormal state. Therefore, it is possible to provide the secondary battery having high reliability.

In addition, the present invention provides a method of manufacturing a secondary battery including an electrode assembly in which positive electrode plates and negative electrode plates are laminated via separators to form a plurality of layer, an encapsulating case for housing the electrode assembly, a lid member for sealing the encapsulating case, and electrolytic solution filled in a battery can constituted of the encapsulating case and the lid member. The method includes the steps of laminating the positive electrode plates, the negative electrode plates, and the separators so as to form a predetermined number of layers of the lamination body unit, providing alignment and anti-misalignment engaging portions constituted of engaging uneven surfaces to contacting surfaces of lamination body units to be stacked, and stacking a plurality of the lamination body units in order using the alignment and anti-misalignment engaging portion so as to form the electrode assembly.

With this structure, the stacked lamination body units are not shifted from each other so that the lamination body unit can be fixed to a correct position. Therefore, even in the large secondary battery including the lamination body in which the multiple positive electrode plates, the multiple negative electrode plates, and the multiple separators are laminated, it is possible to have the structure in which the lamination body is not shifted. Even if an external force such as vibration is applied, there is no abnormal state. Therefore, the secondary battery having high reliability can be manufactured.

In addition, the above-mentioned method of manufacturing a secondary battery according to the present invention further includes the step of providing recesses and salients engaging the uneven surfaces to a ceiling of the lid member facing the electrode assembly and to a bottom surface of the encapsulating case facing the electrode assembly, in which the stacking step is performed so that the encapsulating case and the electrode assembly are not shifted from each other, and the lid member and the electrode assembly are assembled not to be shifted from each other. With this structure, the encapsulating case and the electrode assembly are not shifted from each other, and the lid member and the electrode assembly are not shifted from each other. Even if an external force such as vibration is applied, the electrode assembly in the battery can is not shifted so that there is no abnormal state. Therefore, the secondary battery having high reliability can be manufactured.

In addition, in the above-mentioned method of manufacturing a secondary battery according to the present invention, the uneven surfaces and recesses and salients are formed by adhering tape members made of adhesive tape superior in insulating property and thermal resistance. With this structure, the uneven surfaces for preventing misalignment can be formed easily only by adhering the tape members to predetermined portions.

In addition, in the above-mentioned method of manufacturing a secondary battery according to the present invention, the method includes a unit forming step of forming a lamination body unit by laminating and integrating the positive electrode plates, the negative electrode plates, and the separators to form a predetermined number of layers, an uneven surfaces forming step of adhering the tape members to predetermined portions of the lamination body unit, the encapsulating case, and the lid member, an electrode assembly forming step of stacking the lamination body units in order by engaging the uneven surfaces so as to form the electrode assembly in the encapsulating case, a battery can forming step of attaching the lid member onto the electrode assembly formed in the encapsulating case so as to form the battery can, and a liquid filling step of filling electrolytic solution into the battery can. With this structure, because there is the electrode assembly forming step of stacking the lamination body units in order by engaging the uneven surfaces thereof so as to form the electrode assembly in the encapsulating case, it is possible to manufacture the secondary battery in which the electrode assembly is not shifted even if an external force such as vibration is applied.

### BRIEF DESCRIPTION OF THE DRAWINGS

FIG. 1 is a cross-sectional schematic view illustrating a lamination structure of a secondary battery according to the present invention.

FIG. 2 is a cross-sectional schematic view illustrating a first embodiment of a lamination body unit.

FIG. 3 is a cross-sectional schematic view illustrating a second embodiment of the lamination body unit.

FIG. 4 is a schematic perspective view illustrating a third embodiment of the lamination body unit.

FIG. 5 is a schematic perspective view illustrating a fourth embodiment of the lamination body unit.

FIG. 6A is a plan view illustrating a first pattern example of upper and lower engaging uneven surfaces.

FIG. 6B is a plan view illustrating a second pattern example of the upper and lower engaging uneven surfaces.

FIG. 6C is a plan view illustrating a third pattern example of the upper and lower engaging uneven surfaces.

FIG. 6D is a plan view illustrating a fourth pattern example of the upper and lower engaging uneven surfaces.

FIG. 7 is an exploded perspective view of the secondary battery.

FIG. 8 is an exploded perspective view of the electrode assembly incorporated in the secondary battery.

FIG. 9 is a perspective view illustrating a finished product of the secondary battery.

FIG. 10 is a schematic cross section of the electrode assembly. FIG. 11 is a flowchart illustrating forming steps of the secondary battery.

### DETAILED DESCRIPTION OF THE PREFERRED EMBODIMENTS

Hereinafter, an embodiment of the present invention is described with reference to the attached drawings. In addition, the same components are denoted by the same reference numerals, and overlapping description is omitted.

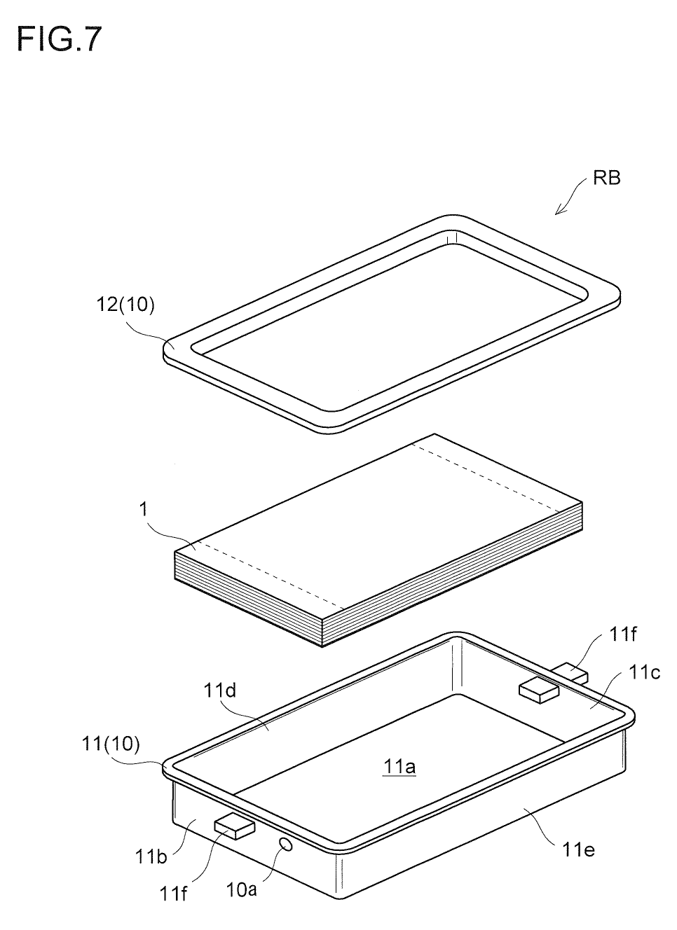

As a secondary battery according to the present invention, a lithium secondary battery is described. For instance, a secondary battery RB according to this embodiment illustrated in FIG. 7 is a lamination type lithium secondary battery and includes a lamination type electrode assembly 1 in which multiple positive electrode plate and multiple negative electrode plates are laminated via separators. In addition, by increasing an electrode plate area and the number of laminated layers, a relatively large capacity of secondary battery can be realized and can be applied to a storage battery for an electric vehicle or a storage battery for storing electric power.

Next, specific structures of the lamination type lithium secondary battery RB and the electrode assembly 1 are described with reference to FIGS. 7 to 10.

As illustrated in FIG. 7, the lamination type lithium secondary battery RB has a rectangular shape in a plan view and includes the electrode assembly 1 in which positive electrode plates, negative electrode plates, and separators are laminated, each of which has a rectangular shape. In addition, the electrode assembly 1 is housed in a battery can 10 having a box shape, constituted of an encapsulating case 11 including a bottom surface 11a and side surfaces 11b to 11e, and a 11d member 12. Charging and discharging are performed using external terminals 11f disposed on side surfaces of the encapsulating case 11 (for example, two opposed side surfaces like side surfaces 11b and 11c).

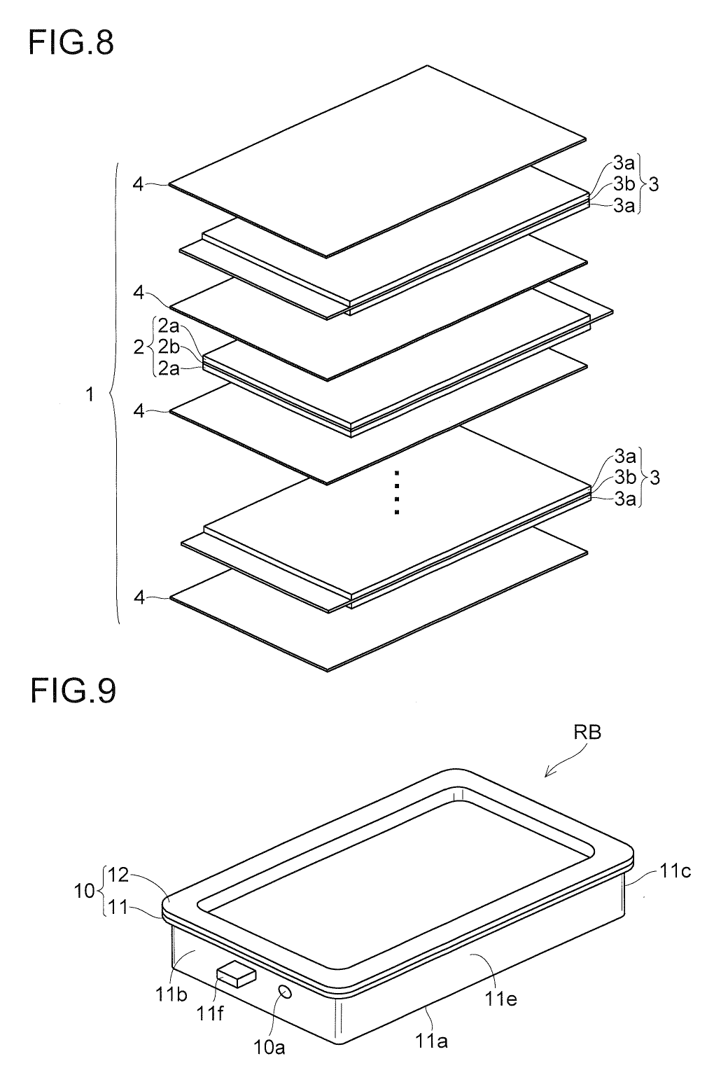

The electrode assembly 1 has a structure in which a plurality of positive electrode plates and a plurality of negative electrode plates are laminated via separators. As illustrated in FIG. 8, a positive electrode active material layer 2a made of positive electrode active material is formed on both sides of a positive electrode collector 2b (for example, aluminum foil) to make a positive electrode plate 2. A negative electrode active material layer 3a made of negative electrode active material is formed on both sides of a negative electrode collector 3b (for example, copper foil) to make a negative electrode plate 3. Then, the positive electrode plates 2 and the negative electrode plates 3 are laminated via separators 4.

The positive electrode plate 2 and the negative electrode plate 3 are insulated from each other by the separator 4, but lithium ions can move between the positive electrode plate 2 and the negative electrode plate 3 through electrolytic solution filled in the encapsulating case 11.

Here, as the positive electrode active material of the positive electrode plate 2, there are oxides containing lithium (such as LiCoO₂, LiNiO₂, LiFeO₂, LiMnO₂, and LiMn₂O₄), and compounds of the oxides in which a part of the transition metal is replaced by other metal element. In particular, by using the material such that 80% or higher of lithium contained in the positive electrode plate 2 can be used for battery reaction as the positive electrode active material, security can be enhanced for an accident such as overcharge.

In addition, as the negative electrode active material of the negative electrode plate 3, there is used a substance containing lithium or a substance in which lithium can be inserted and removed. In particular, in order to realize high energy density, it is preferred to use a material in which a potential for inserting or removing lithium is close to deposition/dissolution potential of the metal lithium. A typical example thereof is a particulate (scale-like, massive, fibrous, whisker, spherical, or crushed particulate) natural graphite or human-made graphite.

Note that in addition to the positive electrode active material of the positive electrode plate 2, or in addition to the negative electrode active material of the negative electrode plate 3, conductive material, thickening agent, integrity, and the like may be contained. The conductive material is not limited a specific material as long as it is an electron conductive material that does not badly affect battery performance of the positive electrode plate 2 or the negative electrode plate 3. For instance, carbonaceous material such as carbon black, acetylene black, ketjen black, graphite (natural graphite or human-made graphite), or carbon fiber, or conductive metal oxide can be used.

As the thickening agent, for example, polyethylene glycols, celluloses, polyacrylamides, poly-N-vinylamides, poly-N-vinylpyrrolidones, or the like can be used. The integrity has a role to combine active material particles and conductive material particles. As the integrity, fluorine polymer such as polyvinylidene fluoride, polyvinyl pyrrolidone, or polytetrafluoroethylene, or polyolefin polymer such as polyethylene or polypropylene, or styrene-butadiene rubber can be used.

In addition, as the separator 4, it is preferred to use a micro-porous high-polymer film. Specifically, it is possible to use a film made of polyolefin high polymer such as nylon, cellulose acetate, nitrocellulose, polysulfone, polyacrylonitrile, polyvinylidene fluoride, polypropylene, polyethylene, polybutene, or the like.

In addition, as the electrolytic solution, it is preferred to use organic electrolytic solution. Specifically, as an organic solvent of the organic electrolytic solution, it is possible to use esters such as ethylene carbonate, propylene carbonate, butylene carbonate, diethyl carbonate, dimethyl carbonate, methylethyl carbonate, γ-butyrolactone, and the like, ethers such as tetrahydrofuran, 2-methyl tetrahydrofuran, dioxane, dioxolane, diethyl ether, dimethoxyethane, diethoxyethane, methoxyethane, and the like, and further, dimethyl sulfoxide, sulfolane, methyl sulfolane, acetonitrile, methyl formate, methyl acetate, and the like. Note that each of these organic solvents can be used by itself, or two or more of them can be used as a mixture.

Further, the organic solvent may contain electrolyte salt. As the electrolyte salt, there are lithium salts such as lithium perchlorate (LiClO₄), lithium fluoroborate, lithium hexafluoride phosphate, trifluoromethane sulfonic acid (LiCF₃SO₃), lithium fluoride, lithium chloride, lithium bromide, lithium iodide, lithium aluminate tetrachloride, and the like. Note that each of these electrolyte salts can be used by itself, or two or more of them can be used as a mixture.

The concentration of the electrolyte salt is not limited to a specific value, but approximately 0.5 to 2.5 mol/L is preferable, and approximately 1.0 to 2.2 mol/L is more preferable. Note that if the concentration of the electrolyte salt is lower than approximately 0.5 mol/L, carrier concentration in the electrolytic solution may be decreased so that resistance of the electrolytic solution may be increased. On the other hand, if the concentration of the electrolyte salt is higher than approximately 2.5 mol/L, dissociation degree of the salt itself may be decreased so that carrier concentration in the electrolytic solution cannot be increased.

The battery can 10 includes the encapsulating case 11 and the lid member 12, which are made of iron, nickel-plated iron, stainless steel, aluminum, or the like. In addition, in this embodiment, as illustrated in FIG. 9, the battery can 10 is formed to have an outside shape that is a substantially flat rectangular shape when the encapsulating case 11 and the lid member 12 are combined.

The encapsulating case 11 has a box shape with a substantially rectangular bottom surface 11a and four side surfaces 11b to 11e rising from the bottom surface 11a, and the electrode assembly 1 is housed in this box. The electrode assembly 1 has a positive electrode collector terminal connected to collector tabs of the positive electrode plates and a negative electrode collector terminal connected to collector tabs of the negative electrode plates, and the external terminals 11f connected electrically to the collector tabs are disposed on side surfaces of the encapsulating case 11, respectively. The external terminals 11f are disposed at two positions of two opposed side surfaces 11b and 11c, for example. In addition, 10a denotes a liquid inlet from which the electrolytic solution is injected.

The electrode assembly 1 is housed in the encapsulating case 11, and each collector terminal is connected to the external terminal. Alternatively, each external terminal is connected to the collector terminal of the electrode assembly 1, which is housed in the encapsulating case 11, and the external terminal is fixed to a predetermined position of the encapsulating case. Then, the lid member 12 is fixed to an opening rim of the encapsulating case 11. Then, the electrode assembly 1 is sandwiched and held between the bottom surface 11a of the encapsulating case 11 and a ceiling of the lid member 12, so that the electrode assembly 1 is retained in the battery can 10. Note that the lid member 12 is fixed to the encapsulating case 11 by means of laser beam welding or the like, for example. In addition, the collector terminal and the external terminal can be connected by using conductive adhesive or the like instead of welding such as ultrasonic welding, laser beam welding, or resistance welding.

As described in the diagram, this lid member 12 may have a dish-like shape in which the part abutting the upper surface of the electrode assembly 1 protrudes so as to engage with the encapsulating case 11, or may have a flat plate shape. The shape is determined appropriately in accordance with a size of the battery can 10 and a thickness of the electrode assembly 1. In any case, the lid member 12 enables the positive electrode plates and the negative electrode plates of the electrode assembly 1 to contact with each other appropriately intimately.

As described above, the lamination type secondary battery according to this embodiment has the structure including the electrode assembly 1 in which multiple positive electrode plates 2 and the negative electrode plates 3 are laminated via the separators 4, the encapsulating case 11 that houses the electrode assembly 1 and is filled with the electrolytic solution, the external terminals 11f provided to the encapsulating case 11, the positive and negative collector terminals for electrically connecting the positive and negative electrode plates and the external terminals 11f, and the lid member 12 fixed to the encapsulating case 11.

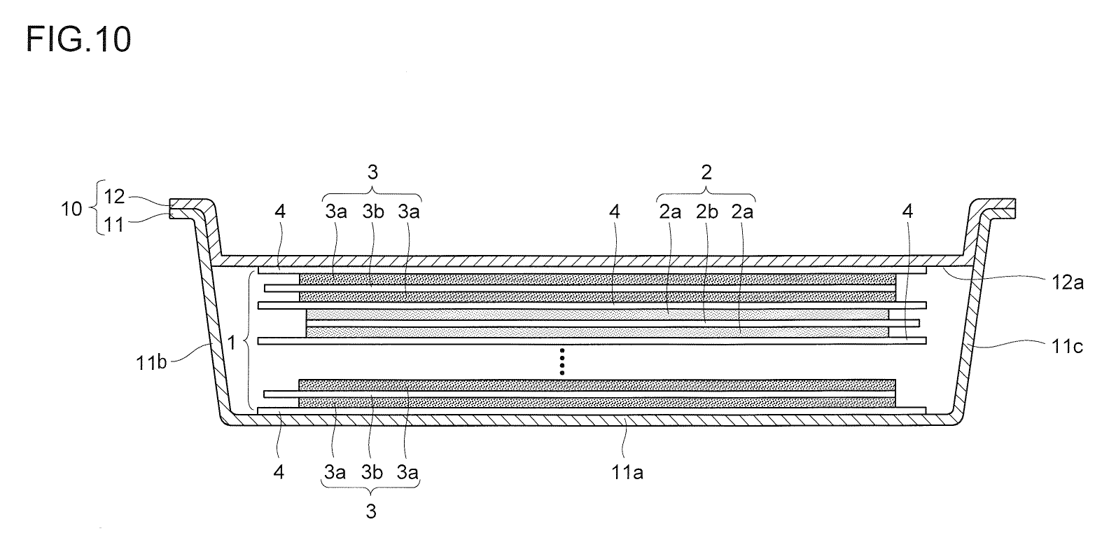

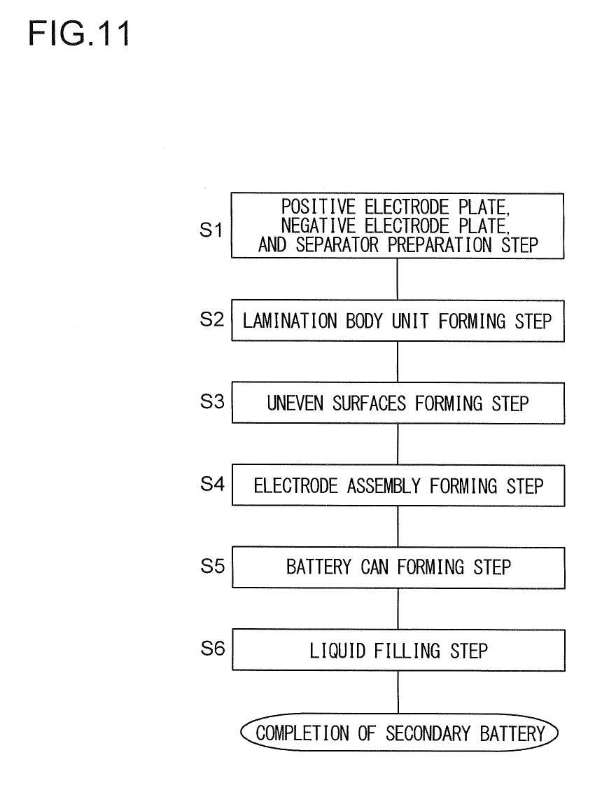

The electrode assembly 1 housed in the encapsulating case 11 includes, for example, as illustrated in FIG. 10, the positive electrode plates 2 in each of which the positive electrode active material layers 2a are formed on both sides of the positive electrode collector 2b, the negative electrode plates 3 in each of which the negative electrode active material layers 3a are formed on both sides of the negative electrode collector 3b, which are laminated via the separators 4, and further the separators 4 on both end surfaces. In addition, instead of the separator 4 on both end surfaces, a resin film made of the same material as the separator 4 may be wound so that the electrode assembly 1 is covered with the insulating resin film. In any case, a member having permeability for the electrolytic solution and insulating property is laminated on the upper surface of the laminated electrode assembly 1. Therefore, the ceiling 12a of the lid member 12 can be directly contacted with the surface, which can be pressed by the lid member at a predetermined pressure.

In addition, in order to manufacture the secondary battery having a large power generation capacity, the electrode plate areas of the positive electrode plate 2 and the negative electrode plate 3 are increased, and the number of laminated layers is also increased. Therefore, predetermined numbers of positive electrode plates 2, negative electrode plates 3, and separators 4 are laminated to make an integrated lamination body unit in advance, and the lamination body units are stacked so that the electrode assembly 1 having a large capacity can be formed.

In addition, when the lamination body units prepared in advance are stacked to make the electrode assembly 1 having a large capacity, it is preferred to stack the lamination body units in the correct position without misalignment and to fix them securely. Therefore, this embodiment provides the secondary battery and the manufacturing method as follows. The electrode assembly 1 has a structure in which the lamination body units are stacked, in each of which predetermined numbers of positive electrode plates 2, negative electrode plates 3, and separators 4 are laminated. There is provided an alignment and anti-misalignment engaging portion on the surface on which the stacked lamination body units contact with each other. Using this alignment and anti-misalignment engaging portion, the lamination body units are aligned and stacked, and misalignment between the lamination body units is suppressed so that they are not shifted from each other after being stacked.

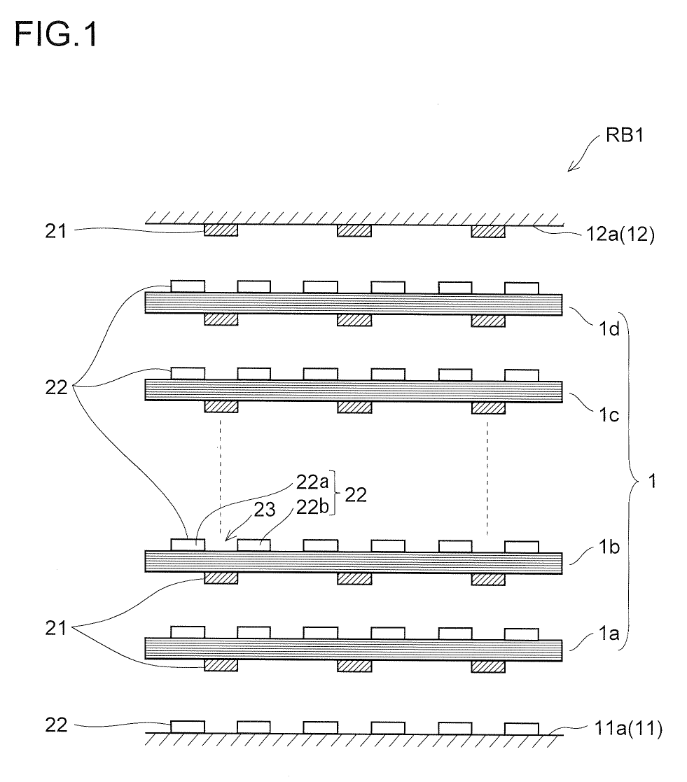

Next, with reference to FIG. 1, there is described a specific embodiment of the secondary battery with the alignment and anti-misalignment engaging portion provided to the surface on which the stacked lamination body units contact with each other so that a plurality of lamination body units can be stacked correctly and that they cannot be shifted after being stacked.

FIG. 1 is a cross-sectional schematic view illustrating a lamination structure of the secondary battery according to this embodiment. This secondary battery RB1 includes the electrode assembly 1 having a structure in which a plurality of lamination body units 1a to 1d are stacked is housed between the bottom surface 11a of the encapsulating case 11 and the ceiling 12a of the lid member 12.

In addition, in this diagram, the lamination body unit 1a and the bottom surface 11a, the lamination body unit 1d and the ceiling 12a, and individual lamination body units are illustrated separately, but it is apparent that they are contacted intimately with each other in reality.

Each of the lamination body units 1a to 1d has a structure including the positive electrode plates 2, the negative electrode plates 3, and the separators disposed between them, which are integrated. These integrated units can be stacked in order. In addition, the number of the electrode plates to be integrated is not limited to a specific value. For instance, in the structure illustrated in FIG. 8, there are nine positive electrode plates 2, ten negative electrode plates 3, and the separators 4 between them, so that the lamination body unit having a predetermined thickness is manufactured.

In addition, as the alignment and anti-misalignment engaging portion provided to the surface for stacking, engaging uneven surfaces are provided so that the upper and lower lamination body units can be stacked correctly and that they are not shifted from each other after being stacked. As to the uneven surfaces, it is sufficient that the contacting surfaces of the upper and lower lamination body units are engaged with each other. For instance, a tape member or a cushioning material having a predetermined thickness are adhered to positions shifted between the upper and lower surfaces so that the uneven surfaces can be formed. In other words, side surfaces of the adhered tape member or cushioning material are engaged with each other so as to form the alignment and anti-misalignment engaging portion.

For instance, as illustrated in the diagram, a tape member having a predetermined width is adhered to the lower surface of each of the lamination body units 1a to 1d so as to make a salient 21. In addition, a pair of tape members 22 (22a and 22b) are adhered to the upper surface at a predetermined interval so as to make a recess 23 having a predetermined width.

In addition, the recess and salient are disposed at a plurality of predetermined positions of the lamination bodies so as to form predetermined engaging uneven surfaces. Using the predetermined engaging uneven surfaces, the lamination bodies are positioned and stacked so that the upper and lower units are fixed in a stable state without misalignment.

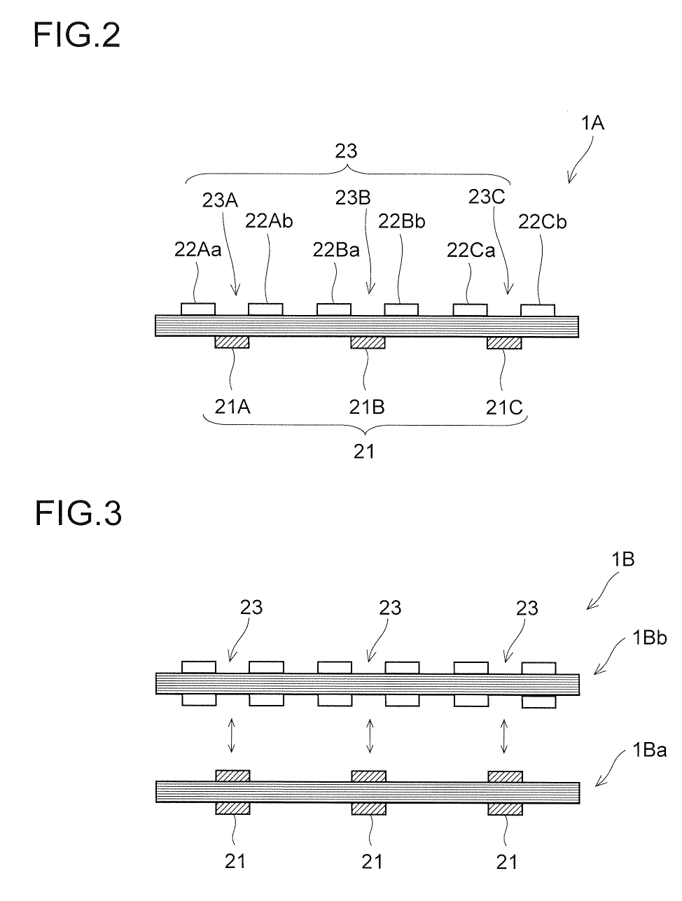

For instance, as a lamination body unit 1A of a first embodiment illustrated in FIG. 2, three tape members are adhered to a first surface for stacking, for example, the lower surface at a predetermined interval so as to form three lines of salients 21 (21A, 21B, and 21C). Further, total six (three pairs of) tape members are adhered to a second surface for stacking, for example, the upper surface so as to form the three lines of recesses 23 (23A, 23B, and 23C).

The recess 23A is formed by a pair of tape members 22Aa and 22Ab adhered in parallel with a predetermined interval. Similarly, the recess 23B is formed by a pair of tape members 22Ba and 22Bb, and the recess 23C is formed by a pair of tape members 22Ca and 22Cb.

In this way, the uneven surface provided to the lower surface for stacking and the uneven surface provided to the upper surface constitute the engaging uneven surfaces. With this structure, only by stacking a plurality of lamination body units 1A in order, the uneven surfaces are engaged with each other so that they are stacked at the correct position, and that they are not shifted from each other after being stacked.

In addition, it is possible to adopt a structure of a lamination body unit 1B of a second embodiment illustrated in FIG. 3, in which the salients 21 are provided to both surfaces of one of the lamination body units, and the recesses 23 are provided to both surfaces of the other lamination body unit, so that the two types of lamination body units are stacked alternately and repeatedly. With this structure, too, when the first units and the second units are stacked alternately, the uneven surfaces thereof are engaged with each other so that they can be stacked correctly, and they are not shifted from each other after being stacked.

For instance, as illustrated in the diagram, a tape member having a predetermined width is adhered to a lower first unit 1Ba so as to form the salient 21, and a pair of tape members are adhered to an upper second unit 1Bb with a predetermined interval so as to form the recess 23. Then, the first units 1Ba and the second units 1Bb are stacked alternately and repeatedly in order, so that the secondary battery having a predetermined number of layers and a predetermined power generation capacity can be manufactured. In other words, the uneven surfaces provided to the upper surface and the lower surface of the first unit 1Ba engage with the uneven surfaces provided to the lower surface and the upper surface of the second unit 1Bb.

In addition, it is preferred to adopt a structure in which the ceiling 12a of the lid member 12 opposed to the electrode assembly 1, as well as the bottom surface 11a of the encapsulating case 11 opposed to the electrode assembly 1 is provided with the recesses or salients engaging the uneven surfaces. With this structure, the encapsulating case 11 and the electrode assembly 1 are not shifted from each other, and the lid member 12 and the electrode assembly 1 are not shifted from each other. Thus, it is possible to provide the secondary battery having high reliability because the electrode assembly 1 in the battery can is not shifted and does not become an abnormal state even if an external force such as vibration is applied. The recesses or salients may be formed by adhering tape members having a predetermined thickness similarly to the uneven surfaces described above, or may be formed as structural recesses or salients.

It is preferred that the tape member adhered for forming the uneven surfaces be an adhesive tape superior in insulating property and thermal resistance (for example, Kapton tape). In addition, it is sufficient that the tape has a thickness that enables engagement with each other, and such that the lamination body units are not shifted after being engaged in a state where they are stacked even if an external force such as vibration is applied. For instance, it is possible to use an adhesive tape having a thickness of approximately 0.5 mm. With this structure, the lamination body units to be electricity generating bodies can be insulated from each other. In addition, even if the lamination body unit becomes high temperature, its durability is maintained so that the predetermined uneven surfaces can be securely maintained.

As to the method of adhering the tape member to a predetermined position, for example, a predetermined template may be used for adhering correctly to a desired position. Therefore, using templates corresponding to individual uneven surfaces for stacking, the engaging uneven surfaces can be formed easily and correctly.

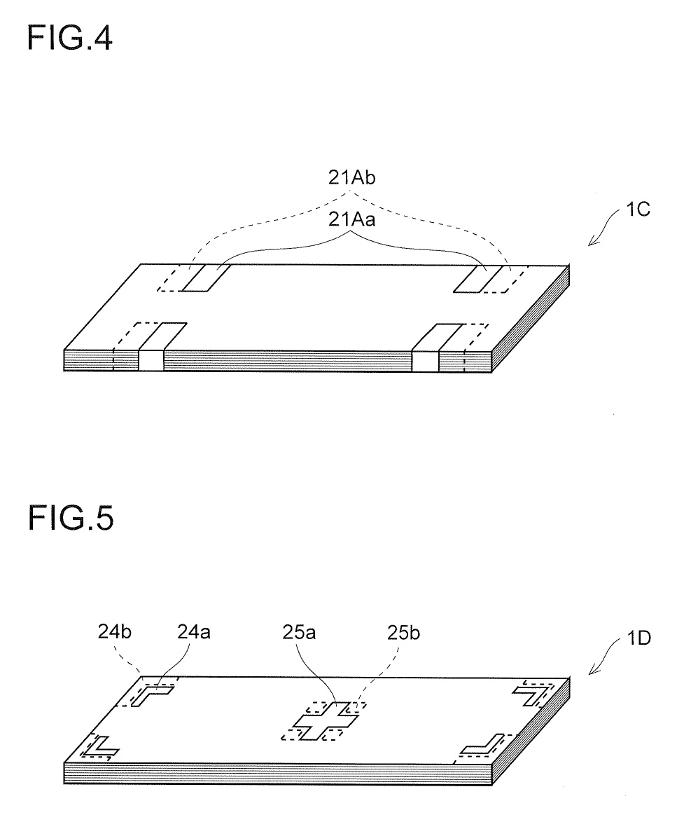

In addition, like a lamination body unit 1C of a third embodiment illustrated in FIG. 4, it is possible to form the uneven surfaces for stacking by using a tape member for fixing the lamination body unit. For instance, first tape members 21Aa indicated by solid lines in the diagram are adhered to the first lamination body unit 1C so as to fix the lamination body. In addition, second tape members 21Ab indicated by broken lines in the diagram are adhered to a second unit that is stacked on the lamination body unit 1C so as to fix the lamination body. Then, these units can be stacked with each other in the correct position with the uneven surfaces constituted of the first tape member 21Aa and the second tape member 21Ab, and after being stacked they are not shifted from each other.

Which this structure, too, it is possible to form the uneven surfaces using the tape members such that the stacked units are not shifted from each other. It is the same structure in that the electrode assembly is constituted of a plurality of stacked and integrated lamination body units in each of which predetermined numbers of the positive electrode plates, negative electrode plates, and separators are laminated and integrated, and that the uneven surfaces are provided to the surfaces on which the stacked lamination body units contact with each other so that position shift between the lamination bodies is suppressed by the uneven surfaces.

In addition, it is desirable that the lamination body units are fixed not to be shifted from each other in the front and rear direction as well as in the left and right direction if a predetermined uneven surface is formed on each surface for stacking instead of using the tape member for fixing the lamination body unit. For instance, like a lamination body unit 1D of a fourth embodiment illustrated in FIG. 5, engaging portions 24a having an L-shape in a plan view are disposed on four corners of the rectangular shape in a plan view, a cross-shaped engaging portion 25a is disposed in the middle portion thereof, while corresponding engaging portions 24b on four corners and an engaging portion 25b in the middle portion are disposed on the other side, so that the units are fixed not to be shifted from each other in the front and rear direction as well as in the left and right direction.

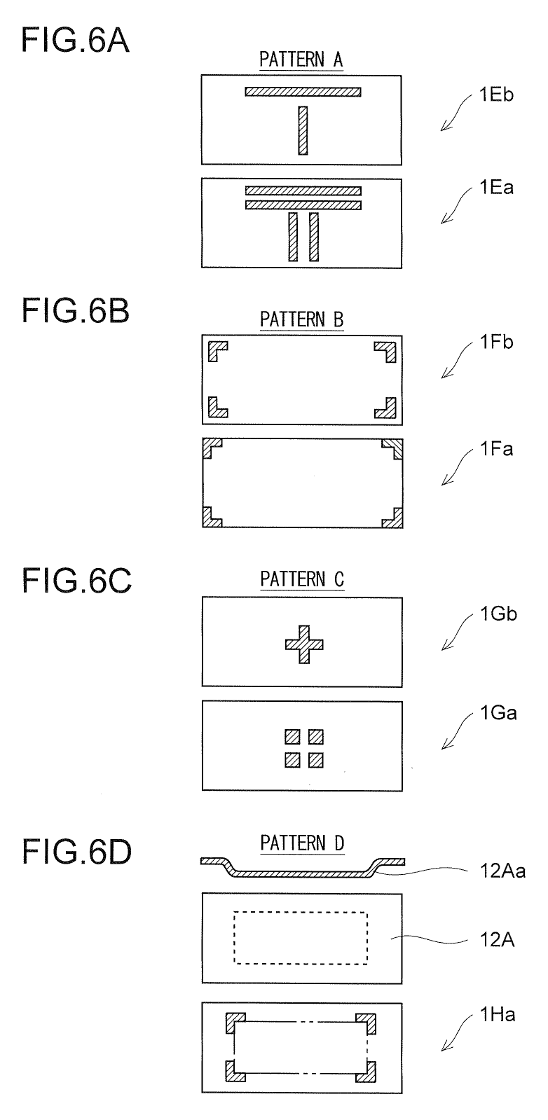

In addition, there are considered various combination patterns for this engagement. Therefore, an embodiment is described with reference to FIGS. 6A to 6D, in which the units were actually manufactured, and vibration tests were performed.

FIG. 6A illustrates a combination example of lamination body units 1Ea and 1Eb of Pattern A in which a T-shaped alignment and anti-misalignment engaging portion in a plan view is formed. In this case, tape members forming a T-shaped engaging recess in a plan view are adhered to one lamination body unit 1Ea, and tape members are adhered to the other lamination body unit 1Eb so that a T-shaped engaging salient in a plan view is formed. With this structure, too, the lamination body units can be vertically stacked in the correct position, and the stacked lamination body units can be fixed not to be shifted in the front and rear direction as well as in the left and right direction.

FIG. 6B illustrates a combination example of lamination body units 1Fa and 1Fb of Pattern B in which L-shaped alignment and anti-misalignment engaging portions in a plan view are formed in four corners. In this case, L-shaped tape members in a plan view are adhered to four corners of one lamination body unit 1Fa, and L-shaped tape members in a plan view engaging the insides of the above-mentioned L-shaped tape members are adhered to the other lamination body unit 1Fb. With this structure, too, the lamination body units can be vertically stacked in the correct position, and the stacked lamination body units can be fixed not to be shifted in the front and rear direction as well as in the left and right direction.

FIG. 6C illustrates a combination example of lamination body units 1Ga and 1Gb of Pattern C in which a cross-shaped alignment and anti-misalignment engaging portion in a plan view is formed in the middle portion. In this case, tape members forming a cross-shaped engaging recess in a plan view are adhered to one lamination body unit 1Ga in the middle portion, and a tape member forming a cross-shaped engaging salient in a plan view is adhered to the other lamination body unit 1Gb in the middle portion. With this structure, too, the lamination body units can be vertically stacked in the correct position, and the stacked lamination body units can be fixed not to be shifted in the front and rear direction as well as in the left and right direction.

FIG. 6D illustrates Pattern D in which the alignment and anti-misalignment engaging portion is formed on the lid member. In this example, a lid member 12A has a ceiling 12Aa protruding downward to abut the upper surface of a lamination body unit 1Ha, and the ceiling 12Aa engages with a rectangular alignment and anti-misalignment engaging portion formed in the middle portion of the lamination body unit 1Ha so as to fix the same. In this case, the tape members are adhered to the middle portion of the lamination body unit 1Ha so as to form a rectangular engaging recess indicated by a phantom line. With this structure, the lamination body unit 1Ha and the lid member 12A are engaged with each other so that the lamination body unit 1Ha is housed in the correct position, and the lamination body unit 1Ha can be fixed to the lid member 12A not to be shifted in the front and rear direction as well as in the left and right direction.

Next, lithium secondary batteries manufactured actually are described.

### EXAMPLES

[Manufacturing of Positive Electrode Plate]

LiFePO₄ (90 part by weight) as the positive electrode active material, acetylene black (5 part by weight) as the conductive material, and polyvinylidene fluoride (5 part by weight) as the integrity were mixed, and N-methyl-2-pyrrolidone as the solvent was appropriately added so that the materials are dispersed, and hence slurry was prepared. This slurry was uniformly applied onto both sides of an aluminum foil as the positive electrode collector (having a thickness of 20 μm). Then, the slurry was dried and compressed by a roll press, and it was cut into a predetermined size to make the plate-like positive electrode plate 2.

In addition, the manufactured positive electrode plate had a size of 140×250 mm and a thickness of 230 μm, and nine positive electrode plates 2 were used for each lamination body unit.

[Manufacturing of Negative Electrode Plate]

Natural graphite (90 part by weight) as the negative electrode active material, and polyvinylidene fluoride (10 part by weight) as the integrity were mixed, and N-methyl-2-pyrrolidone as the solvent was appropriately added so that the materials are dispersed, and hence slurry was prepared. This slurry was uniformly applied onto both sides of a copper foil as the negative electrode collector (having a thickness of 16 μm). Then, the slurry was dried and compressed by a roll press, and it was cut into a predetermined size to make the plate-like negative electrode plate 3.

In addition, the manufactured negative electrode plate had a size of 142×255 mm and a thickness of 146 μm, and ten negative electrode plates 3 were used for forming the lamination body unit.

In addition, as the separators, polyethylene films having a size of 145×255 mm and a thickness of 25 μm were manufactured.

[Preparation of Nonaqueous Electrolytic Solution]

The nonaqueous electrolytic solution was prepared by dissolving 1 mol/L of LiPF₆ in mixed liquid (solvent) in which ethylene carbonate (EC) and diethyl carbonate (DEC) are mixed by a volume ratio of 30:70.

[Manufacturing of Battery Can]

The encapsulating case and the lid member constituting the battery can were manufactured using nickel-plated iron sheet as their material. In addition, each of them had a thickness of 0.8 mm, and the rectangular lithium secondary battery with an openable and closable inlet plug having a battery can size of 320×150×40 mm as internal dimensions of length, width, and depth was manufactured. In addition, in order to make intimate contact between the lid member and the upper surface of the electrode assembly, not a flat plate but a dish-like lid member fitting in the can was used. Using the dish-like lid member, a shifting when the lid member is welded can be prevented so that the welding work can be facilitated. In addition, by changing the sinking depth of the dish-like lid member, it is easy to respond to a variation of thickness of the housed electrode assembly. Further, the dish-like shape is preferable for increasing strength of the lid member and strength of the battery can.

[Assemble of Secondary Battery]

The positive electrode plates and the negative electrode plates are alternately laminated via separators. In this case, nine positive electrodes, ten negative electrode plates, and eighteen separators are laminated so that not the positive electrode plate but the negative electrode plate is positioned on each outside. Then, this lamination body was wound with a polyethylene film having the same thickness of 25 μm as the separator. Thus, the lamination body unit was manufactured, and four lamination body units were stacked to make the electrode assembly (lamination body).

A size of the separator disposed between the positive and negative electrode plates is 145×255 mm as described above, which is a little larger than the positive electrode plate (140×250) or the negative electrode plate (142×255). Thus, the active material layers formed on the positive electrode plate and the negative electrode plate can be securely covered. In addition, a connection piece of the collector member (collector terminal) was connected to a collector exposing portion of the positive electrode and a collector exposing portion of the negative electrode.

The electrode assembly connected to the collector terminal was housed in the encapsulating case, the collector terminal and the external terminal were connected to each other, the lid member was attached and sealed, and nonaqueous electrolytic solution was put in through a liquid inlet hole by reducing pressure. After the solution was filled, the liquid inlet hole is sealed. Thus, five secondary batteries of each embodiment were manufactured.

In Example 1, when the positive electrode plate, the separator, and the negative electrode plate were laminated, a tape member (Pattern A) was disposed between them. In Examples 2 to 5, a tape member is adhered to a predetermined portion of the lamination body unit. Example 2 is a secondary battery corresponding to the combination pattern A, Example 3 is a secondary battery corresponding to the combination pattern B, Example 4 is a secondary battery corresponding to the combination pattern C, and Example 5 is a secondary battery corresponding to the combination pattern B+D. In addition, in Examples 2 to 5, a tape member having a thickness of 0.5 mm and a width of 10 mm was used. In Example 1, a thinner tape member was used (having a thickness of preferably 0.1 mm or smaller, and in this embodiment 0.08 mm).

[Manufacturing Comparative Example]

As a secondary battery of a comparative example, there were manufactured the secondary batteries in which the uneven surface for preventing misalignment is not formed between laminated electrode plates or on the lamination body unit, and just intimate contact was made between the lid member and the lamination body unit. In this case, the step depth of the salient provided to the lid member is increased by a sum of thicknesses of tape members if adhered for forming the uneven surfaces.

Each five secondary batteries of Examples 1 to 5 and five secondary batteries of the comparative example were assembled, and charged capacity of each of them was checked after a predetermined vibration test. If the checked charged capacity is low, the sample was disassembled and checked whether or not the lamination body unit was shifted and how much extent the lamination body unit was shifted (a maximum shift with respect to the lowermost lamination body unit). A result of this experiment is shown in Table 1.

The vibration test was performed in three axes directions (x axis, y axis, and z axis) for 3 hours and 45 minutes each (total 11 hours 15 minutes). In addition, the vibration frequency was varied from 5 Hz to 200 Hz to 5 Hz with an acceleration varied from 1 G to 8 G to 1 G. One set of 15 minutes test was repeated 15 times (corresponding to 3 hours 45 minutes).

TABLE 1

| | | | NON- | DISASSEMBLED | | |
|---|---|---|---|---|---|---|
| | | NUMBER OF | DEFECTIVE | AND CHECKED | VISUAL | SHIFT |
| | PATTERN | SAMPLES | UNITS | (SAMPLES/5) | CHECK | (mm) |
| EXAMPLE 1 | PATTERN A | 5 | 5 | 1/5 | NO PROBLEM | 1.5 |
| | (ELECTRODE | | | | | |
| | PLATE) | | | | | |
| EXAMPLE 2 | PATTERN A | 5 | 5 | 1/5 | NO PROBLEM | 1.0 |
| | (LAMINATION | | | | | |
| | BODY) | | | | | |
| EXAMPLE 3 | PATTERN A | 5 | 5 | 1/5 | NO PROBLEM | 1.5 |
| | (LAMINATION | | | | | |
| | BODY) | | | | | |
| EXAMPLE 4 | PATTERN A | 5 | 5 | 1/5 | SHIFT | 2.0 |
| | (LAMINATION | | | | OBSERVED | |
| | BODY) | | | | | |
| EXAMPLE 5 | PATTERN B + D | 5 | 5 | 1/5 | NO PROBLEM | 1.2 |
| | (LAMINATION | | | | | |
| | BODY) | | | | | |
| COMPARATIVE | WITHOUT | 5 | 1 | 5/5 | COLLECTOR PORTION | 6.0 |
| EXAMPLE 1 | UNEVEN | | | | DAMAGE OF 2 | |
| | SURFACES | | | | COLLECTOR PORTION | 7.0 |
| | | | | | DAMAGE OF 2 | |
| | | | | | LAMINATION BODY | 3.5 |
| | | | | | SHIFT OF 1 | |

As shown in Table 1, as for Example 1 having the alignment and anti-misalignment engaging portion between laminated electrode plates, and as for Examples 2 to 5 having the alignment and anti-misalignment engaging portion on the surface for stacking of the lamination body units, each one sample having a lowest charged capacity was disassembled so as to check a shift of the lamination body unit in the electrode assembly and a damage to the collector terminal portion. As a result, no one has a damage to the collector terminal or the connection portion between the collector terminal and the external terminal, and every one was in a normal state. In addition, a shift of the lamination body unit was approximately 1.0 mm at most in Pattern A having the uneven surfaces on the lamination body unit, and approximately 1.5 mm at most in Pattern B. In Pattern C having the uneven surfaces in the middle portion of the collector, a shift of 2.0 mm at most was observed.

In this way, a shift of the lamination body can be suppressed also by disposing the alignment and anti-misalignment engaging portion in a predetermined portion when the electrode plates are laminated to form the lamination body. However, it is preferred to dispose the alignment and anti-misalignment engaging portion not between the electrode plates but on the surface for stacking of the lamination body unit, because a shift of the lamination body can be suppressed by a simpler structure. In addition, the shift is decreased from 1.5 mm to 1.2 mm in Example 5 in which the recess and salient are formed on the lid member so as to form the alignment and anti-misalignment engaging portion in addition to Pattern B of Example 3. It is understood that the shift of the lamination body is further suppressed.

As for Comparative example 1 without the uneven surfaces, all the five units including one having relatively good charged capacity were disassembled and checked. Then, there were two units having a broken collector portion (a shift was 7.0 mm), and two units having a damage to the collector portion (a shift was 6.0 mm). The one without a damage to the collector portion had a shift of 3.5 mm at most. Therefore, in the lamination structure without the alignment and anti-misalignment engaging portion, the lamination body may be shifted by action of a large external force so that there may be a damage to the connection portion of the collector terminal.

As described above, it was understood that if the uneven surfaces for suppressing a shift of each lamination body unit is not formed and the alignment and anti-misalignment engaging portion is not provided when the plurality of lamination body unit are stacked to form the electrode assembly 1, a shift of 7.0 mm at most was generated by the vibration test so that there was a damage to the collector portion. In addition, according to this embodiment in which the uneven surfaces are formed so as to provide the alignment and anti-misalignment engaging portion on the contacting surfaces of the lamination body units to be stacked, it was checked that a shift after the vibration test was only 2.0 mm at most so that there was no damage to the collector terminal portion.

Next, a manufacturing method of the secondary battery according to this embodiment is further described.

The manufacturing method of a secondary battery according to this embodiment is a manufacturing method of the secondary battery including the electrode assembly in which the positive electrode plates and the negative electrode plates are laminated via the separators, the encapsulating case for housing the electrode assembly, the lid member for sealing the encapsulating case, and the electrolytic solution filled in the battery can constituted of the encapsulating case and the lid member. In addition, the electrode assembly is formed by stacking a plurality of the lamination body units in each of which the positive electrode plates, the negative electrode plates, and the separators are laminated and integrated to form a predetermined number of layers. The alignment and anti-misalignment engaging portions constituted of the engaging uneven surfaces are formed on the contacting surfaces of the lamination body units to be stacked. Using the alignment and anti-misalignment engaging portions, the plurality of lamination body units are stacked in order so as to form the electrode assembly.

According to this manufacturing method, the stacked lamination body units are not shifted from each other, and the lamination body units can be fixed to a correct position. Therefore, even in the large secondary battery including the lamination body in which the multiple positive electrode plates, the multiple negative electrode plates, and the multiple separators are laminated, it is possible to have the structure in which the lamination body is not shifted. Even if an external force such as vibration is applied, there is no damage to the terminal portion or the like, and there is no abnormal state. Thus, it is possible to manufacture the secondary battery having high reliability.

In addition, the recess and salient engaging the uneven surface is provided to the ceiling of the lid member facing the electrode assembly and to the bottom surface of the encapsulating case facing the electrode assembly, so that the encapsulating case and the electrode assembly are not shifted from each other, and that the lid member and the electrode assembly are not shifted from each other in the assembly step. With this structure, the encapsulating case and the electrode assembly as well as the lid member and the electrode assembly are not shifted from each other. Therefore, even if an external force such as vibration is applied, the electrode assembly in the battery can is not shifted and does not become an abnormal state. Therefore, it is possible to manufacture the secondary battery having high reliability.

The above-mentioned uneven surface and the recess and salient are formed by adhering tape members made of adhesive tape having good insulating property and thermal resistance. With this structure, only by adhering the tape member to a predetermined portion, it is possible to form the uneven surfaces for preventing misalignment easily and preferably.

In other words, as illustrated in FIG. 11, the manufacturing method of a secondary battery of this embodiment includes a preparation step S1 of preparing the positive electrode plates, the negative electrode plates, the separators and the like, a lamination body unit forming step S2 of assembling them, an uneven surfaces forming step S3 of forming the uneven surfaces by adhering the tape members on a predetermined portion of the manufactured lamination body unit, an electrode assembly forming step S4 of stacking the lamination body units with the predetermined uneven surfaces in order and housing the same in the encapsulating case so as to form the electrode assembly, a battery can forming step S5 of attaching the lid member to the encapsulating case and sealing them, and a liquid filling step S6 of filling the electrolytic solution in the sealed battery can.

As described above, the manufacturing method of the secondary battery according to this embodiment includes the electrode assembly forming step of stacking the lamination body units in order while engaging the uneven surfaces so as to form the electrode assembly in the encapsulating case. Therefore, when the lamination body units are once stacked, and pressed and sealed by the lid member, the lamination body units are not shifted from each other. Therefore, it is possible to manufacture the secondary battery in which the electrode assembly is not shifted even if an external force such as vibration is applied.

In addition, because the uneven surface provided to the lamination body unit is formed by adhering the adhesive tape having good insulating property and thermal resistance, the uneven surface can be provided to an arbitrary and appropriate position so that the work can be facilitated. In addition, it is possible to insulate between the lamination body units to be the electricity generating body. Even if the lamination body unit becomes high temperature, its durability is maintained, and the predetermined uneven surfaces are securely maintained so that dimension stability of the secondary battery is maintained.

As described above, according to the secondary battery of this embodiment, the stacked lamination body units are not shifted so that the lamination body unit can be fixed to a correct position. Therefore, even in the large secondary battery including the lamination body in which the multiple positive electrode plates, the multiple negative electrode plates, and the multiple separators are laminated, it is possible to have the structure in which the lamination body is not shifted. Even if an external force such as vibration is applied, there is no damage to the collector terminal or the external terminal, and there is no abnormal state so that the secondary battery with high reliability can be obtained.

In addition, according to the manufacturing method of the secondary battery according to this embodiment, in the uneven surfaces forming step of adhering the predetermined tape members to predetermined portions of the lamination body unit, the encapsulating case, and the lid member, the uneven surfaces are formed at positions for correctly engaging the stacked lamination body units. Therefore, the lamination body units can be stacked correctly. Even if an external force such as vibration is applied, the lamination body units are not shifted from each other. Therefore, even if an external force such as vibration is applied, the electrode assembly is not shifted, and there is no damage to the collector terminal or the connection portion between the collector terminal and the external terminal, so that it is possible to manufacture the secondary battery having a stable performance.

As described above, according to the present invention, the alignment and anti-misalignment engaging portion are formed on the contacting surfaces of the lamination body units to be stacked, and the lamination body units are aligned and stacked by positioning with the alignment and anti-misalignment engaging portions. Therefore, even in the large secondary battery including the lamination body in which the multiple positive electrode plates, the multiple negative electrode plates, and the separators are laminated, the lamination bodies can be stacked correctly without misalignment. Even if an external force such as vibration is applied, the lamination body is not shifted, the terminal portion is not shifted, and there is not damage to the same. Thus, it is possible to provide the secondary battery with high reliability and the manufacturing method thereof.

Therefore, the secondary battery according to the present invention can be appropriately used as a storage battery having large capacity to which a large scale and stable performance are demanded.

What is claimed is:

1. A secondary battery comprising:
an electrode assembly in which positive electrode plates and negative electrode plates are laminated via separators to form a plurality of layers;
an encapsulating case for housing the electrode assembly;
a lid member for sealing the encapsulating case; and
electrolytic solution filled in a battery can constituted of the encapsulating case and the lid member, wherein
the electrode assembly is constituted of a plurality of stacked lamination body units in which the positive electrode plates, the negative electrode plates, and the separators are laminated to form a predetermined number of layers, alignment and anti-misalignment engaging portions are provided to contacting surfaces of the lamination body units to be stacked, and the lamination body units are positioned and stacked using the alignment and anti-misalignment engaging portions.

2. The secondary battery according to claim 1, wherein the alignment and anti-misalignment engaging portions have engaging uneven surfaces.

3. The secondary battery according to claim 2, wherein the uneven surfaces are formed using tape members adhered to outer surfaces of the lamination body units.

4. The secondary battery according to claim 3, wherein the tape members are made of adhesive tape superior in insulating property and thermal resistance.

5. The secondary battery according to claim 2, wherein the lamination body units includes first units and second units each of which has predetermined uneven surfaces on the upper surface and the lower surface, the first units and the second units are stacked alternately and repeatedly so as to form the electrode assembly, and the uneven surfaces formed on the upper surface and the lower surface of the first unit engage with the uneven surfaces formed on the lower surface and the upper surface of the second unit.

6. The secondary battery according to claim 2, wherein the lamination body units has an uneven surface formed on the lower surface and an uneven surface formed on the upper surface, which constitute the engaging uneven surfaces.

7. The secondary battery according to claim 2, wherein recesses and salients engaging the uneven surfaces are formed on a ceiling of the lid member facing the electrode assembly and on a bottom surface of the encapsulating case facing the electrode assembly.

8. A method of manufacturing a secondary battery including an electrode assembly in which positive electrode plates and negative electrode plates are laminated via separators to form a plurality of layer, an encapsulating case for housing the electrode assembly, a lid member for sealing the encapsulating case, and electrolytic solution filled in a battery can constituted of the encapsulating case and the lid member, the method comprising the steps of:
laminating the positive electrode plates, the negative electrode plates, and the separators so as to form a predetermined number of layers of the lamination body unit;
providing alignment and anti-misalignment engaging portions constituted of engaging uneven surfaces to contacting surfaces of lamination body units to be stacked; and
stacking a plurality of the lamination body units in order using the alignment and anti-misalignment engaging portion so as to form the electrode assembly.

9. The method of manufacturing a secondary battery according to claim 8, further comprising the step of providing recesses and salients engaging the uneven surfaces to a ceiling of the lid member facing the electrode assembly and to a bottom surface of the encapsulating case facing the electrode assembly, wherein the stacking step is performed so that the encapsulating case and the electrode assembly are not shifted from each other, and the lid member and the electrode assembly are assembled not to be shifted from each other.

10. The method of manufacturing a secondary battery according to claim 9, wherein the uneven surfaces and recesses and salients are formed by adhering tape members made of adhesive tape superior in insulating property and thermal resistance.

11. The method of manufacturing a secondary battery according to claim 8, comprising:
a unit forming step of forming a lamination body unit by laminating and integrating the positive electrode plates, the negative electrode plates, and the separators to form a predetermined number of layers;
an uneven surfaces forming step of adhering the tape members to predetermined portions of the lamination body unit, the encapsulating case, and the lid member;
an electrode assembly forming step of stacking the lamination body units in order by engaging the uneven surfaces so as to form the electrode assembly in the encapsulating case;
a battery can forming step of attaching the lid member onto the electrode assembly formed in the encapsulating case so as to form the battery can; and
a liquid filling step of filling electrolytic solution into the battery can.
